(19) United States
(12) Patent Application Publication
(10) Pub. No.: US 2007/0047597 A1
(43) Pub. Date: Mar. 1, 2007

(54) Pulse picking and cleaning in short pulse high energy fiber laser system

(75) Inventors: Jian Liu, Sunnyvale, CA (US); Jiangfan Xia, Santa Clara, CA (US)

Correspondence Address: Bo-In Lin, 13445 Mandoli Drive, Los Altos Hills, CA, 94022, US

(73) Assignee: PolarOnyx, Inc.

(21) Appl. No.: 11/512,896

(22) Filed: Aug. 29, 2006

Related U.S. Application Data
(60) Provisional application No. 60/713,650, filed on Aug. 29, 2005.
(60) Provisional application No. 60/713,653, filed on Aug. 29, 2005.
(60) Provisional application No. 60/713,654, filed on Aug. 29, 2005.
(60) Provisional application No. 60/714,468, filed on Sep. 1, 2005.
(60) Provisional application No. 60/714,570, filed on Sep. 7, 2005.

(51) Int. Cl. H01S 3/30; H01S 3/098

(52) U.S. Cl. 372/6; 372/18; 372/700

(57) ABSTRACT

A Chirped pulse amplification (CPA) fiber laser system. The CPA fiber laser system includes a fiber mode-locking oscillator for generating a laser to project to a pulse stretcher for stretching a pulse width of the laser. The CPA fiber laser system further includes a pulse picking up device to pick up selected pulses for projecting to a multistage amplifier chain for generating an amplified laser to project to a compressor for compressing the amplified laser. The CPA fiber laser system is enabled to generate an output laser having a power up to few μJ for 10 KHz pulses with a pumping power as low as 100 mW.

This Formal Application claims a Priority Date of Aug. 29, 2005 benefited from a Provisional Patent Application 60/713,650, 60/713,653, and 60/713,654 and a Priority Date of Sep. 1, 2005 benefited from Provisional Application 60/714,468 and 60/714,570 filed by one of the same Applicants of this application.

### FIELD OF THE INVENTION

The present invention relates generally to apparatuses and methods for providing fiber laser system. More particularly, this invention relates a design for pulse picking and cleaning in high-energy short pulse fiber laser system typically implemented as a Chirped Pulse Amplification (CPA) fiber laser system.

### BACKGROUND OF THE INVENTION

Even though current technologies of fiber laser have made significant progress toward achieving a compact and reliable fiber laser system providing high quality output laser with ever increasing output energy, however those of ordinary skill in the art are still confronted with technical limitations and difficulties. Specifically, in a fiber laser system implemented with the Chirped Pulse Amplification (CPA) for short pulse high power laser amplifier, the CPA systems are still limited by the technical difficulties that the mode-locked (ML) oscillator always has a high repetition rate, conventionally 40˜100 MHz. Under certain average power, it is hard to get very high pulse energy if one keeps such a high repetition rate. In a typical short-pulse high-energy fiber laser system, the idea of Chirped Pulse Amplification (CPA) is widely implemented. Basically it consists of four parts: a mode-locking (ML) oscillator for providing short laser pulse, a stretcher to get long pulse duration, an amplifier to get high energy, and a compressor to get short pulse and high peak power. For a lot of applications, high pulse energy and peak power is more interested instead of high repetition rate and/or high average power. In fiber laser system, if the laser system provides an option for selecting some pulses from the high repetition rate ML oscillator as the target pulse for amplification under same average power and/or same pumping level, the laser system is able to amply these picked-up pulses with much higher energy and peak power.

Therefore, a need still exists in the art of designing and configuring a fiber laser system to provide a new and improved configuration and method to provide fiber laser to pickup high-energy pulses to effective amplify these selected high pulses thus generating laser pulse with high peaks that are more suitable for broader scoped of applications such that the above-discussed difficulty may be resolved.

### SUMMARY OF THE PRESENT INVENTION

It is therefore an aspect of the present invention to provide a high-energy short-pulse laser system with a new configuration implemented with a pulse picking up device to pick up pulses over many periods of fix length of time for effective amplification to provide high peak pulses. The system enhances the ability to get high-energy pulses with relatively low pumping level. Consequently, a laser system is enabled to generate as high as a few μJ for 10 KHz pulses with as low as 100 mW pump with feasibility to produce a few hundred μJ 10-100 KHz pulses such that the above-discussed difficulties as that encountered in the prior art may be resolved.

It is another aspect of this invention to provide a high-energy short-pulse laser system with a new configuration by implementing a pulse cleaning up device using Acoustic optic devices to resolve the background issue that leads to power loss often occurs in a laser system operated at a medium repetition rate. The pulse cleaner does not change the pulse repetition rate and reduces the background for a system of medium repetition rate. This new system configuration brings the contrast ratio up to more than 60 dB. Even for 10 KHz system and the signal carries 100 times higher average power higher than the background thus totally resolve the technical difficulties caused by the background issue.

It is another aspect of this invention to provide a high-energy short-pulse laser system with a new configuration by implementing a pulse cleaning up device using Acoustic optic devices that further suppress the Amplified Spontaneous Emission (ASE) noise. In addition to the benefits of resolving the difficulties caused by the background issued, additional performance advantages are therefore achieved.

Briefly, in a preferred embodiment, the present invention discloses a fiber Chirped Pulse Amplification (CPA) laser system that includes a fiber mode-locking oscillator, a fiber stretcher, a pulse picking up device, a multistage amplifier chain and a pulse width compressor. In a preferred embodiment, the system further includes a pulse cleaning up device after a first stage of the multiple state amplification chain.

In a preferred embodiment, this invention further discloses a method for overcoming the drawback in a fiber CPA laser system by implementing a pulse picking up system to selectively pick up high peak pulse for effective amplification. Additionally, in order to overcome the difficulties caused by the background issued, pulses cleaning up devices are used to provide signal pulses significantly greater than the background pulses thus overcoming the background issues.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a functional block diagram for showing a fiber laser system implemented with a pulse picking-up device of this invention.

FIG. 2 shows the working principle of the AO device in pulse picking up application. A transverse acoustic wave passes through the AO material, the first order diffraction beam comes out with an angle respect to the transmission beam. As the AO wave is off, the gate for the diffraction beam is closed. Thus, the pulse is picked up.

FIG. 3 shows a functional block diagram for showing a fiber laser system implemented with a pulse picking-up device and a pulse cleaning up device of this invention.

FIG. 4 Picked pulse and the background peaks. The lower DC components below the background are ASE. (Amplified-Spontaneous-Emission)

### DETAILED DESCRIPTION OF THE INVENTION

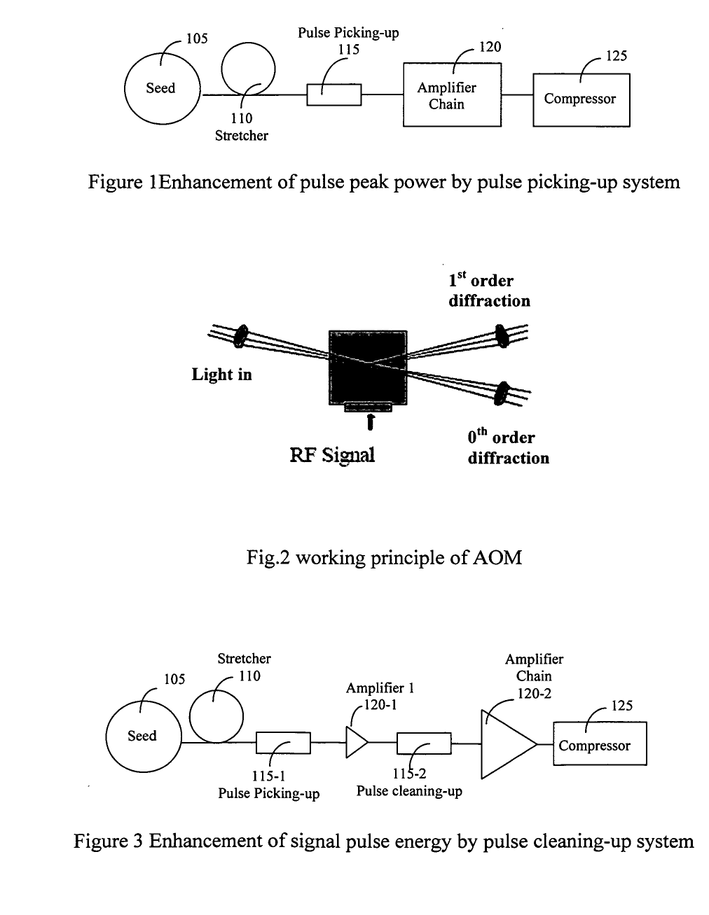

Referring to FIG. 1 for a schematic diagram of a fiber laser system 100 of this invention that implements a dispersion compensator of this invention. The laser system 100 includes a laser seed 105 as a mode-locked oscillator for generating a seed laser for projecting into a laser stretcher 110 to stretch the laser pulse. The stretcher 110 generates laser pulse with stretched pulse width is projected into a pulse picking-up device 115 to pick up a selected pulse within a certain period. The pulse picking up device 115 is required to pick up one pulse among hundreds to thousands of pulses. The critical issue is to assure there is one and only one pulse that is picked up during certain period. This means two folds of requirements. First, during a specific period, all other pulses not picked up are removed and secondly, after the period, in a next period of identical length, the next pulse is picked up again. To fulfill these requirements, two different devices are available for practical implementation. There are electric-optic devices that can pick up sub Hz to a few KHz pulses from ˜100 MHz ML pulse train. The electric optical devices can combine with polarization component to reduce the intensity of the other pulses by 10ˆ4 times. The combined pulse picking up device thus achieves an extinction ratio of approximately 10ˆ−4. Additionally, the Acoustic-optic (AO) device can also pick up a few KHz to a few MHz from the ML pulse train, with an extinction ratio of 10ˆ−4. The former device has been widely used in solid-state laser system, generated mJ to Joule energy, corresponding to TW (10ˆ12 W) to PW (10ˆ15 W) peak power. In fiber CPA laser system as shown in FIG. 1, a pulse picking up device is implemented with an Acoustic-optical pulse picking up device to produce μJ to mJ energy, corresponding to GW to TW peak power. The Acoustic optical pulse picking up device 115 as shown is practically useful for the all fiber-based device in fiber CPA laser system. This largely enhances the ability to get high-energy pulses with relatively low pumping level. Consequently, a laser system is provided that is able to generate laser pulses as high as a few μJ of output power for 10 KHz pulses with as low as 100 mW pump. It is therefore possible to proceed to a next goal of producing laser pulse with output energy of a few hundred μJ as the 10-100 KHz pulses.

In general, the Acoustic-Optic devices are used in laser equipment for electronic control of the intensity and position of the laser beam. Acoustic-optic interaction occurs in all optical mediums when an acoustic wave and a laser beam are present in the medium. When an acoustic wave is launched into the optical medium, it generates a refractive index wave that behaves like a sinusoidal grating. An incident laser beam passing through this grating will diffract the laser beam into several orders. With appropriate design, the first order beam has the highest efficiency. Its angular position is linearly proportional to the acoustic frequency, so that the higher the frequency, the larger the diffracted angle. The first order diffraction beam is always utilized to realize the highest contrast ratio. Without the AO wave, the beam comes out from the zero order diffraction direction (i.e., the transmission direction), as shown in FIG. 2. There is nothing from the first order diffraction beam port. As the AO wave is launched, the first order diffraction beam comes out. When the AO wave is synchronized with the input mode-locking pulse train, by fine-tuning the relative delay with the mode-locking pulse train, and the duration of the AO wave, one or a series of pulses can be picked up from the pulse train. This process is generally referred to as the pulse picking up. This process reduces the pulse repetition rate without losing the other features, such as the pulse energy, the spectrum, the pulse width, etc. When integrated with the fiber optics, this device can be more robust and stable, and keep the beam quality of the laser.

Referring to FIG. 1 again, the pulses picked up by the picking up device 115 are projected to a series of laser amplifiers 120 to amplify the laser into higher energy. The amplified laser is then projected into a pulse compressor 125 to re-compress the pulse width of the laser to output a laser with original pulse width.

The above high-energy short-pulse laser system however encounters particular technical issues, especially while running at medium repetition rate. For higher repetition rate, like >1 MHz, the power loss induced by the pulse picking-up operation is generally not very high (˜10-20 dB). However, when the contrast ratio is higher than 30 dB, most of the power is still carried in the selected pulses as transmitted by the selected signals. For lower repetition rate, like <100 Hz, although the signal carries less average power, the amplification favors these picked pulses due to the dynamic gain in the gain fiber since the lifetime of the gain fiber (Yb or Er) is less than 10 ms. For the medium repetition rate, typically 10-100 KHz, the average power loss is 30-40 dB, the signal will carry less average power than the residual peaks. The energy loss will turn worse with longer amplifiers chain and higher energy level since the residual peaks increase faster than the signal when the signal enters saturation amplification regime and the residual peaks are still in small signal amplification regime. The contrast ratio will be lower, and more power goes into the residual peaks. Even the signal is amplified, the power conversion efficiency of the signal can not be high. Such technical difficulty is generally referred to as the “background issue”.

In order to resolve this background issue, a pulse cleaning up operation is added to a new and improved laser system as shown in FIG. 3 of this invention. The main thrust of the invention is to introduce a second pulse picker 115-2 right after the initial amplifier 120-1, synchronizing it with the first pulse pickerm 115-1, and having it run at exact same repetition rate. The second pulse picker device 115-2 is functioning as pulse cleaner. The pulse cleaning operation does not change the pulse repetition rate and the pulse cleaning operation helps to reduce the background. In a typical implementation, for medium repetition rate pulse picking-up of 10-100 KHz, two Acoustic optical (AO) devices are used. This setup brings the contrast ratio up to more than 60 dB. Even for a system operated at 10 KHz, the signal carries an average power that is 100 times higher than the background. For such a system operated at 100 KHz, about 99.9% power lies in the signal. The background issue is almost totally resolved. The pulse cleaner can achieve an advantage that is more than background reduction. When the pulse cleaning up device is placed after one or two stages of amplifier, the pulse cleaner 115-2 can also help to reduce the Amplified Spontaneous Emission (ASE) noise. As background peaks are suppressed, the low level ASE becomes an issue, especially after high gain amplifier. Thus the pulse cleaner can clean the residual peaks, and the ASE as well.

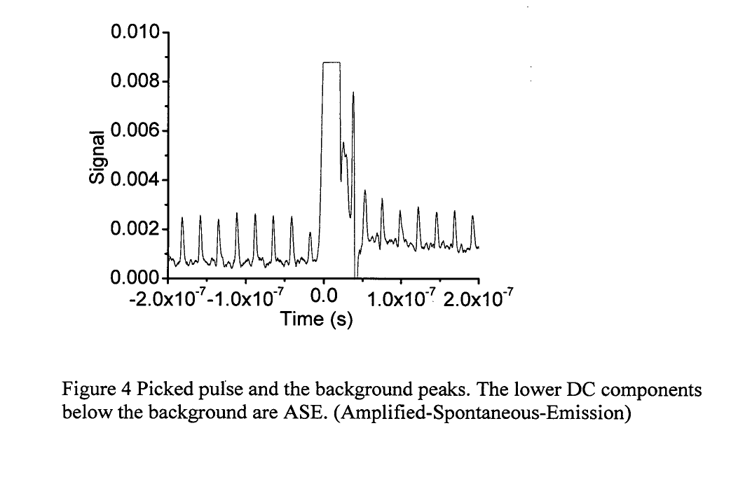

The ASE issue becomes critical as two conditions are fulfilled. First, the background peaks is largely suppressed; second, the signal power is very low. Referring to FIG. 3, after the pulse picker, the signal is quite low. The input for Amplifier 1 is too low to suppress the ASE. The ASE will build up in the initial amplifiers right after the pulse picker. Further, without suppression it will dominate the amplifier chain thereafter since it comes from the gain peak in the lasing spectrum. Most of the power will go into the ASE instead of the signal. FIG. 4 shows the light pulses after Amplifier 1. The pulse with a greater amplitude is the picked pulse and this pulse exceeds the scale. All of the other pulses are the background peaks. The lower DC components below the background are ASE. The ASE can be easily amplified and built up during the amplified chain. There will be a few methods to clean the ASE. One can use spectral filter to remove it if it has different spectral distribution with the signal. However, if the ASE and the signal have same spectrum, we will have to use our pulse cleaner to remove it. Instead of spectrally removing the ASE, the pulse cleaner removes the ASE in the time domain. The AO device can deflect the ASE to other directions and only the picked pulse can pass through the second AO modulator.

With the improved laser system, it is feasible to further increase the output power to produce an output laser of few hundred μJ at 10-100 KHz pulses. Therefore, by applying a system with pulse picking and cleaning the improved system provides the possibility to develop an all fiber solution for mJ level high-energy short pulse CPA system.

According to above descriptions and drawings, this invention discloses a Chirped pulse amplification (CPA) fiber laser system. The CPA fiber laser system includes a fiber mode-locking oscillator for generating a laser to project to a pulse stretcher for stretching a pulse width of the laser. The CPA fiber laser system further includes a pulse picking up device to pick up selected pulses for projecting to a multistage amplifier chain for generating an amplified laser to project to a compressor for compressing the amplified laser. The CPA fiber laser system is enabled to generate an output laser having a power up to few μJ for 10 KHz pulses with a pumping power as low as 100 mW. In another preferred embodiment, the CPA fiber laser system is enabled to generate an output laser having a power up to few hundred μJ for 10-100 KHz pulses. The CPA fiber laser system further includes a pulse cleaning-up device right after an initial amplifier of the multistage amplifier chain for reducing background signal noises for further enhancing performance of the multistage amplifier chain. The pulse cleaning-up device further includes an Acoustic optic device for reducing the background signal noises. Furthermore, the pulse cleaning-up device having a same pulse repetition rate of the fiber mode-locking oscillator for increasing a contrast ratio of the laser pulses. In a preferred embodiment, the pulse cleaning-up device having a same pulse repetition rate of the fiber mode-locking oscillator for increasing a contrast ratio of the laser pulses to more than 60 dB. In another preferred embodiment, the pulse cleaning-up device having a same pulse repetition rate of the fiber mode-locking oscillator for increasing a contrast ratio of the laser pulses whereby an average power of laser signals is about one hundred times higher than the background signal noises. In another preferred embodiment, the pulse cleaning-up device having a same pulse repetition rate of the fiber mode-locking oscillator for increasing a contrast ratio of the laser pulses whereby Amplified Spontaneous Emission (ASE) noises are also suppressed. In a preferred embodiment, the pulse picking-up device is provided for picking one pulse among hundred to thousand pulses and removing other pulses not picked. In a different embodiment, the pulse picking-up device is provided for picking one pulse in a time period and picking up another identical pulse in a next time period. In another preferred embodiment, the pulse picking-up device further includes an electric optical device for picking up sub-Hz to a few KHz pulses from ˜100 MHz ML pulse train. In yet another preferred embodiment, the pulse picking-up device further includes an electric optical device combined with a polarization component for reducing pulse amplitude of other pulse not selected. In another preferred embodiment, the pulse picking-up device further includes an electric optical device combined with a polarization component for reducing an intensity of other pulse not selected to an extinction ratio of approximately 10ˆ−4.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A Chirped pulse amplification (CPA) fiber laser system comprising:
a fiber mode-locking oscillator for generating a laser to project to a pulse stretcher for stretching a pulse width of said laser; and
a pulse picking up device to pick up selected pulses for projecting to a multistage amplifier chain for generating an amplified laser to project to a compressor for compressing said amplified laser.

2. The fiber CPA fiber laser system of claim 1 wherein:
said CPA fiber laser system is enabled to generate an output laser having a power up to few μJ for 10 KHz pulses with a pumping power as low as 100 mW.

3. The fiber CPA fiber laser system of claim 1 wherein:
said CPA fiber laser system is enabled to generate an output laser having a power up to few hundred μJ for 10-100 KHz pulses.

4. The fiber CPA laser system of claim 1 further comprising:
a pulse cleaning-up device right after an initial amplifier of said multistage amplifier chain for reducing background signal noises for further enhancing performance of said multistage amplifier chain.

5. The fiber CPA laser system of claim 4 wherein:
said pulse cleaning-up device further comprising Acoustic optic device for reducing said background signal noises.

6. The fiber CPA laser system of claim 4 wherein:
said pulse cleaning-up device having a same pulse repetition rate of said fiber mode-locking oscillator for increasing a contrast ratio of said laser pulses.

7. The fiber CPA laser system of claim 4 wherein:
said pulse cleaning-up device having a same pulse repetition rate of said fiber mode-locking oscillator for increasing a contrast ratio of said laser pulses to more than 60 dB.

8. The fiber CPA laser system of claim 4 wherein:
said pulse cleaning-up device having a same pulse repetition rate of said fiber mode-locking oscillator for increasing a contrast ratio of said laser pulses whereby an average power of laser signals is about one hundred times higher than said background signal noises.

9. The fiber CPA laser system of claim 4 wherein:
said pulse cleaning-up device having a same pulse repetition rate of said fiber mode-locking oscillator for increasing a contrast ratio of said laser pulses whereby Amplified Spontaneous Emission (ASE) noises are also suppressed.

10. The fiber CPA fiber laser system of claim 1 wherein:
said pulse picking-up device is provided for picking one pulse among hundred to thousand pulses and removing other pulses not picked.

11. The fiber CPA fiber laser system of claim 1 wherein:
said pulse picking-up device is provided for picking one pulse in a time period and picking up another identical pulse in a next time period.

12. The fiber CPA fiber laser system of claim 1 wherein:
said pulse picking-up device further comprising an electric optical device for picking up sub-Hz to a few KHz pulses from ˜100 MHz ML pulse train.

13. The fiber CPA fiber laser system of claim 1 wherein:
said pulse picking-up device further comprising an electric optical device combined with a polarization component for reducing an pulse amplitude of other pulse not selected.

14. The fiber CPA fiber laser system of claim 1 wherein:
said pulse picking-up device further comprising an electric optical device combined with a polarization component for reducing an intensity of other pulse not selected to an extinction ratio of approximately 10ˆ−4.
